(19) United States
(12) Patent Application Publication
(10) Pub. No.: US 2007/0234800 A1
(43) Pub. Date: Oct. 11, 2007

(54) Level sensor

(75) Inventors: Jeffrey S. Stout, Steward, IL (US); Jeffrey S. Cole, Sandwich, IL (US)

Correspondence Address: REINHART BOERNER VAN DEUREN P.C., 2215 PERRYGREEN WAY, ROCKFORD, IL, 61107, US

(73) Assignee: Monitor Technologies LLC, Elburn, IL (US)

(21) Appl. No.: 11/401,503

(22) Filed: Apr. 11, 2006

(51) Int. Cl. G01F 23/38; G01F 23/00; G01F 25/00

(52) U.S. Cl. 73/314; 73/317; 73/DIG. 5; 73/293; 73/1.73; 73/290 R

(57) ABSTRACT

A apparatus for sensing a surface of material in a storage container is provided. The apparatus comprises a housing, a motor assembly, a swing arm assembly, an optical assembly, a material surface detector, and an electronic control circuit. The motor assembly has a motor and a reel carrying a cable. The swing arm assembly has a swing arm with a magnet and a sensor circuit. The sensor circuit monitors a magnetic flux to determine a surface detector position. The optical assembly has a measuring wheel, a code wheel, and an optical encoder circuit. The optical encoder circuit monitors rotation of the code wheel. When the surface detector is moved between first and second positions based upon input from the sensor circuit, the control circuit receives input from the optical encoder circuit based on the rotation of the code wheel. As such, the surface of the material is sensed.

### FIELD OF THE INVENTION

This invention generally relates to level sensors and, in particular, to a level sensor suitable for sensing a level of a material in a storage container.

### BACKGROUND OF THE INVENTION

Bin monitors are used to monitor the level of materials at various discrete locations in storage bins, hoppers, tanks, silos or other structures. Monitor units can be installed almost anywhere materials are stored and can be used in a wide variety of applications, such as, for example, with: feed, silica sand, rocks, pellets, wood, calcium dust, rubber, metals, regrind materials, coal, peanuts, malt, clays, resin, limestone, grain, foundry materials, sand pre-mix, rawhide, sawdust, and many other applications.

Monitor Technologies, LLC, the assignee of the instant application, manufactures and sells bin monitors such as, for example, the bin monitor disclosed in U.S. Pat. No. 6,696,965 to Stout, et al. These bin monitors are typically installed through a roof or a wall of a storage container. As such, the bin monitors are able to locate a surface of the material and/or determine an amount of material inside the storage container.

While bin monitors such as those sold by Monitor Technologies, LLC, the assignee of the present application, have met with substantial commercial success, there is always a desire to improve the accuracy of the bin monitor. In particular, the use of optics in the bin monitors has been attempted, but such sensors are subject to accumulation of dust on the lenses and related equipment. Dust can be especially problematic in dry bulk powders such as at grain elevators. Sealing the monitor housing is only effective up to a point and has not effectively eliminated the dust sufficiently for optical devices to maintain their accuracy.

Further areas of improvement pertain to providing more than a simple “on/off” type of motor control capability, to giving the bin monitor the ability to check for errors and detect particular conditions, and to improving the accuracy of level measurements provided by the bin monitor.

### BRIEF SUMMARY OF THE INVENTION

The invention provides a bin monitor that improves upon accuracy through a sensor that provides feedback to indicate whether another sensor (e.g., optical sensor) is operating properly and providing accurate results and/or data. The bin monitor includes a housing that forms a magnetically penetrable bulkhead. The mechanical components are disposed on one side of the bulkhead in a mechanical compartment while the electrical components are disposed on another side of the bulkhead in an electrical compartment. Moreover, since the mechanical compartment houses a swing arm carrying a magnet and the electrical compartment includes one or more hall effect sensors, the bin monitor is able to sense a position of the swing arm. A portion of the housing also forms an optical compartment within the electrical compartment. The optical sensor is located in the optical compartment such that the optical sensor is redundantly isolated from the mechanical compartment, which is where contaminants are more prevalent. In addition, the optical sensor is able to detect errors, detect known conditions, and determine a direction of rotation.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a front elevation view of an exemplary embodiment of a bin monitor, constructed in accordance with the teachings of the present invention, the bin monitor operably coupled to a storage container and having a portion of a housing cut away to expose a mechanical compartment;

FIG. 2 is a side elevation view of the bin monitor of FIG. 1 including dashed lines to illustrate a bulkhead disposed within the housing; and

FIG. 3 is a rear elevation view of the bin monitor of FIG. 1, the bin monitor disengaged from the storage container and having a portion of the housing cut away to expose an electrical compartment.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

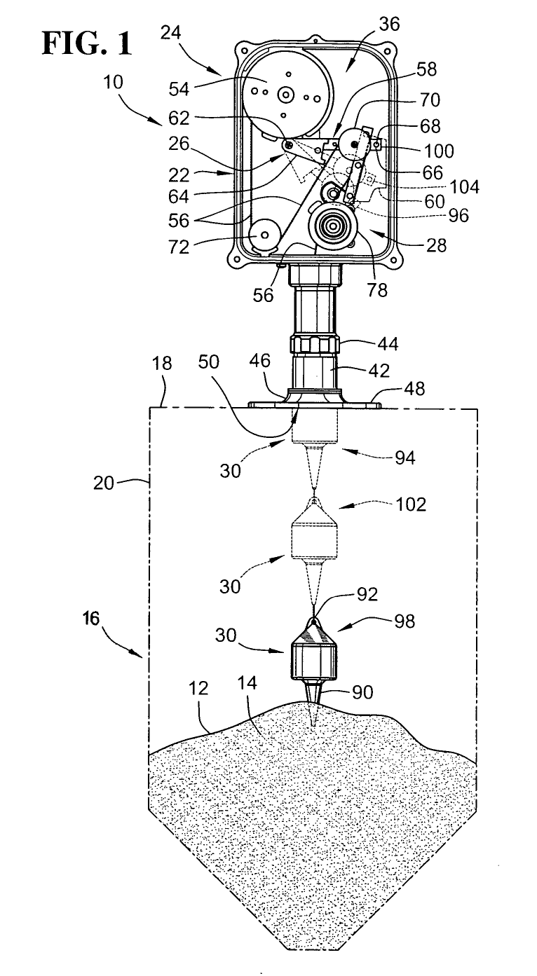

Referring to FIG. 1, a monitor 10 for sensing a level 12 of material 14 in a material storage vessel 16 is shown. The monitor 10 is shown centrally mounted upon and/or secured to a roof 18 vertically disposed above a wall 20 of the storage vessel 16. The storage vessel 16 (i.e., containment vessel, storage container, storage bin, etc.) is configured to hold, at least temporarily, the material 14. The material 14 can be, for example, feed, plastic pellets, aggregates, limestone, powders, bulk chemicals, rocks, liquids, plastic regrind, grains, cement, coal, sand, oils, and the like. The level 12 or top surface of the material 14 in the storage vessel 16 can be uneven, as shown in FIG. 1, or can be generally flat (i.e., planar) when, for example, a liquid is being held.

As collectively shown in FIGS. 1-3, the monitor 10 comprises a housing 22, a motor assembly 24, a swing arm assembly 26, an optical assembly 28, a material surface detector 30, and an electronic control circuit 32. To permit the swing arm assembly 26 to be more easily and conveniently viewed, a portion of the electronic control circuit 32 has been cut away and removed.

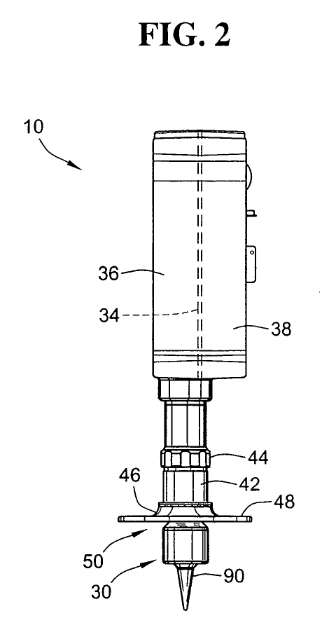

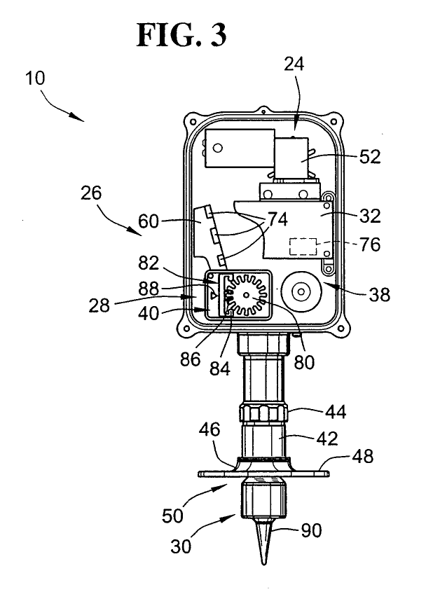

As best shown in FIG. 2, the housing 22 forms a bulkhead 34 (i.e., a partition wall) that divides the housing into a mechanical compartment 36 and an electrical compartment 38. The bulkhead 34 is configured to keep contaminants from the mechanical compartment 36 out of the electrical compartment 38. To perform this function, seals, gaskets, and other similar parts (not shown) can be disposed between the bulkhead 34 and the remainder of the housing 22. As will be explained more fully below, the bulkhead 34 separates mechanical components from electrical components without hindering the operation of either. In addition and referring in general to FIG. 3, the housing 22 also forms an optical compartment 40 situated within the electrical compartment 38. Again, as will be explained more fully below, the optical compartment 40 shields one or more sensitive optical components from contaminants such as, for example, dust, dirt, chaff, and the like. To perform this function, seals, gaskets, and other similar parts (not shown) can be disposed between the optical compartment 40 and the remainder of the housing 22 and/or the electrical compartment 38.

The housing 22 can be constructed using one or more of a variety of suitable materials. For example, the housing 22 can be formed in part or entirely from metal, plastic, and the like. Also, the housing 22 can be formed from two or more shells or layers of material so as to provide a plurality of contaminant barriers. In addition, seals, gaskets, and other similar parts (not shown) can be disposed between engaged portions of the housing 22 in an effort to protect internal components from contaminants. In a preferred embodiment, the bulkhead 34 is formed from a material that does not substantially interfere with a magnetic field such as, for example, aluminum, plastic, and the like.

As illustrated in FIG. 1, the housing 22 also forms a neck 42. The neck 42 is a generally hollow, cylindrical portion of the housing 22 that extends downwardly toward the storage vessel 16. As shown in FIG. 2, the neck 42 is generally oriented forward of the electrical compartment 38 and directly beneath the mechanical compartment 34. Therefore, contaminants from the storage vessel 16 must breach the bulkhead 34 to gain access to the electrical compartment 38. If desired, the neck 42 can include a coupling mechanism 44 that permits quick engagement and disengagement of all or a portion of the monitor 10 from the storage vessel 16. As shown in FIG. 1, the coupling mechanism 44 is a threaded ring rotatable about a top portion of the neck 42 and threadably engageable with mating threads on a bottom portion of the neck.

The housing 22 further includes and forms a socket 46 and has a mounting flange 48. As shown in FIG. 1, the mounting flange 48 is a configured to mount on the storage vessel 16 such that the monitor 10 and the storage vessel are operatively coupled together. The socket 46 has an open end 50 directed toward and exposed to the inside of the storage vessel 16. As such, the neck 42 and socket 46 generally provide the monitor 10 with a conduit and/or passageway to the material 14. The socket 46 is sized and dimensioned to receive and couple with the material surface detector 30.

The motor assembly 24 is generally disposed in the housing 22 and includes a motor 52 and a reel 54 (i.e., storage reel) configured to carry a cable 56. In one embodiment, the cable 56 is a heavy duty, stainless steel cable. Alternatively, the cable 56 can be formed from other suitable cordage materials. As shown in FIG. 3, the motor 52 is preferably a compact electric motor 52 disposed in the electrical compartment 38. Referring to FIG. 1, the reel 54 and the cable 56 are situated in the mechanical compartment 36. Even though separated from each other by the bulkhead 34, the reel 54 and the motor 52 are operably coupled together. Therefore, when actuated, the motor 52 is able to rotate the reel 54 in either a clockwise or counterclockwise direction. Because the cable 56 is anchored to the reel 54, the reel is able to alternatively dispense or collect the cable. As illustrated in FIG. 1, when the reel 54 is rotated clockwise, more of the cable 56 is wrapped about the reel. In contrast, when the reel 54 is rotated counterclockwise, the reel releases more of the cable 56.

The swing arm assembly 26 controls and/or is responsive to tension in the cable 56. The swing arm assembly 26 is generally disposed in the housing 22 and includes a swing arm 58 and a sensor circuit 60. As shown in FIG. 1, a first distal end 62 of the swing arm 58 is pivotably secured to the housing 22. The first distal end 62 can be situated within a swing arm brace 64 or support that is pivotably mounted to the housing 22 and/or the swing arm 58. The swing arm brace 64 generally moves with or relative to the swing arm 58. The swing arm 58 is biased upwardly away from the storage vessel 16 by a biasing member such as a spring, a hydraulic cylinder, a pneumatic piston, and the like (not shown). A second distal end 66 of the swing arm carries a magnet 68. In one embodiment, the magnet 68 is a neodymium nickel plated magnet although numerous other types of magnets can also be suitable used.

Between the first and second distal ends 62, 66, the swing arm 58 includes a pulley 70. In one embodiment, as shown in FIG. 1, the cable 56 held by the reel 54 is routed around a directional pulley 72, which is secured to the bottom of the housing 22, and then passes over and around the pulley 70 mounted on the swing arm 58. As such, the swing arm 58 is operably coupled to the cable 56. When the reel 54 winds the cable 56, the swing arm 58 may pivot slightly downwardly (toward the storage vessel 16 in FIG. 1). In contrast, when the reel 54 unwinds the cable 56, the swing arm 58 may pivot slightly upwardly (away from the storage vessel 16). As shown in FIG. 1, the swing arm 58 is disposed in the mechanical compartment 36 of the housing 22.

The sensor circuit 60 shown in FIG. 3 includes a position sensor other than an optical sensor, which may take the form of one or more hall effect sensors 74. As well known by those skilled in the art, each hall effect sensor 74 is an electronic device that varies an output voltage in response to changes in a magnetic field intensity (i.e., magnetic flux density). The sensor circuit 60 is located in the electrical compartment 38 and is physically separated from the swing arm 58 by the bulkhead 34. Even so, the hall effect sensors 74 are able to sense the magnetic field generated by the magnet 68 and produce voltages. Using these voltages, a microprocessor 76 on the electronic control circuit 32 (or the sensor circuit 60) uses an algorithm to determine the position of the magnet 68 relative to the hall effect sensors 74 and, therefore, the position of the swing arm 58 relative to the housing 22. In other words, the voltages produced by the hall effect sensors 74 are indicative of the position of the swing arm 58. If an array or series of hall effect sensors 74 is utilized by the sensor circuit 60, the position of the wing arm 58 can be monitored throughout its entire range of motion.

The optical assembly 28 includes a measuring wheel 78, a code wheel 80, and an optical encoder circuit 82. The cable 56 is routed around and engages the measuring wheel 78. Therefore, when the reel 54 winds the cable 56, the measuring wheel 78 is, for example, rotated clockwise and, in contrast, when the reel unwinds the cable, the measuring wheel 78 is rotated counterclockwise. The measuring wheel 78 is operably coupled to the code wheel 80 and, therefore, when the measuring wheel is rotated the code wheel 80 also rotates. As illustrated in FIG. 1, the measuring wheel 78 is disposed within the mechanical compartment 36.

The code wheel 80 and the optical encoder circuit 82 are disposed in the optical compartment 40 found within the electrical compartment 38. Preferably, the optical compartment 40 is sealed off from the electrical compartment 38. Therefore, the code wheel 80 and the encoder circuit 82 are twice insulated from contaminants that originate within the storage vessel 16. Once due to the fact that the optical compartment 40 is sealed off from the electrical compartment 38 and twice because the electrical compartment is sealed off from the mechanical compartment 36 by the bulkhead 34. Any contaminants found outside the storage vessel 16 and proximate the monitor 10 must compromise at least a third layer of protection in the form of the housing 22 itself.

The code wheel 80 includes coded patterns of opaque and transparent sectors and the optical encoder circuit 82 generally includes at least one light source 84 and at least one photo detector 86 (i.e., optical sensor). Light from the light source 84 shines through the transparent sectors and gets blocked by the opaque sectors. As a result, when the code wheel 80 is rotated, light is intermittently received by the photo detector 86. Each time light is detected, the photo detector 86 generates a pulse or signal. In contrast, when the light is blocked a pulse or signal is not generated. The pulses or signals are generally relayed to the electrical control circuit 32. Since the code wheel 80 rotates relative to the measuring wheel 78, the pulses directly correspond to the length of cable 56 that has been released or collected and the electronic control circuit 32 is able to determine the level. 12 of material 14.

The optical encoder circuit 82 is also configured to sense direction of rotation (e.g., clockwise or counterclockwise) of the code wheel 80 in addition to sensing the length of the cable 56 dispensed or retracted. For example, in one embodiment the optical encoder circuit 82 includes a quadrature encoder and the code wheel 80 has two parallel code tracks that are offset from each other such that the opaque and transparent sectors of the parallel code tracks are not aligned. As a result, the quadrature encoder outputs two pulse trains (e.g., A and B) ninety degrees out of phase. If pulse train A leads pulse train B, for example, the electronic control circuit 32 is advised that the code wheel 80 is rotating in a clockwise direction. If pulse train B leads pulse train A, the electronic control circuit 32 is advised that the code wheel 80 is rotating in a counterclockwise direction. In other words, the quadrature outputs permit the direction of rotation of the code wheel 80 to be determined. This prevents an inaccurate count of pulses due to an undesirable “bounce” in the cable 56 that can occur when the material surface detector 30 is raised and lowered. Specifically, the pulses can be added or subtracted based on the direction of rotation of the code wheel 80.

In another embodiment, the optical encoder circuit 82 includes more than one light source 84 and/or more than one photo detector 86. For example, two photo detectors 86, one light source 84, and a code wheel 80 with two code tracks can be employed. Each of the two photo detectors 86 is oriented with respect to one or the other of the code tracks. Since the code tracks are offset, the rotation of the code wheel can be determined. In another case, two photo detectors 86, two light sources 84, and a code wheel 80 with a single code track can be used. The two photo detectors 86 are offset at different angles compared to the equidistant angles between the teeth on the code wheel 80. Once again, the rotation of the code wheel can be determined by this arrangement.

With either configuration of light sources 84 and photo detectors 86, the optical encoder circuit 82 is able to determine whether the code wheel 80 is rotating in either a clockwise or counterclockwise direction (i.e., a forward or reverse direction).

In one embodiment the optical encoder circuit 82 includes an amplifying device 88 such as, for example, an operational amplifier. The amplifying device 88 immediately amplifies or strengthens the pulse or signal generated by the photo detector 86. This amplification inhibits or prevents the degradation of the pulse such that the signal can be beneficially used and analyzed by the electronic control circuit 32.

The material surface detector 30 is a device generally configured to engage the material 14 within the storage vessel 16 and provide an indication of the level 12 of the material. In the illustrated embodiment of FIG. 1, the material surface detector 30 is a plumb bob having a conical tip 90 at one end and a securing member 92 (e.g., eyelet, hook, etc.) at another end. The cable 56 is generally secured to the securing member 92 and, thereafter, travels upwardly through the socket 46 and the neck 42 of the housing 22 until the cable 56 engages the measuring wheel 78 as discussed above. Should the material 14 in the storage vessel 16 be a liquid, the material surface detector 30 can be a float or similar buoyant device to indicate when the material 14 has been engaged.

The material surface detector 30 is able to move into and between several positions relative to the storage vessel 16 and/or the monitor 10. For example, when the reel 54 has fully retracted the cable 56, the material surface detector 30 engages with the socket 46 and assumes a “socketed” position 94. When the material surface detector 30 takes the socketed position 94, the downward force of the cable 56 upon the swing arm 58 increases and pulls the swing arm into a corresponding socketed position 96 proximate the measuring wheel 78. In contrast, when the reel 54 has expended the cable 56 until the material surface detector 30 has contacted the level 12 of the material 14, the material surface detector is in a “material contact” position 98. When the material surface detector 30 takes the material contact position 98, the downward force of the cable 56 upon the swing arm 58 decreases and/or is eliminated and permits the swing arm 58 to move upwardly into a corresponding material contact position 100 away from the storage vessel 16. Finally, when the material surface detector 30 is moving between the socketed position 94 and the material contact position 98, the material surface detector is said to be in a “traveling” position 102 (moving either upwardly or downwardly) between the socketed and material contact positions. Likewise, the swing arm 58 settles into a corresponding traveling position 104.

The electronic control circuit 32 (i.e., main control station) is a computing device such as a programmable logic device, a programmable logic controller, a computer, and the like disposed in the electrical compartment 38. The electric control circuit 32 is operably coupled to the motor 52, the sensor circuit 60, and the optical encoder circuit 82. The electronic control circuit 32 is able to activate and deactivate the motor 52. In particular, the electronic control circuit 32 can instruct the motor 52 to move the material surface detector 30 between the socketed position 94 and the material contact position 98 based upon input from the sensor circuit 60.

The electronic control circuit 32 also receives input from the photo detector 86 in the optical encoder circuit 82 based on the amount and direction of rotation of the code wheel 80. The input typically comes in the form of a series of pulses or signals generated by the photo detector 86. When these pulses are counted, surface or level 12 of the material 14 in the storage vessel 16 can be quickly determined. If any undesirable bounce in the cable 56 was noticed, the electronic control circuit 32 is able to adjust the level reading by adding to or subtracting from the pulse count depending on the direction of rotation of the code wheel 80. This is in contrast to simply adding a count for every pulse created and provides for more accurate results when ascertaining the level 12. With the level 12 of the material 14 known, the electronic control circuit 32, peripheral hardware and/or software are able to calculate and determine one or more parameters (e.g., amount, volume, temperature, pressure, etc.) of the material 14 within the storage vessel 16.

In operation, when a measurement cycle is initiated the material surface detector 30 and the swing arm 58 are in their socketed positions 94, 96 and the electronic control circuit 32 activates the motor 52. The activated motor 52 begins to turn the reel 54 such that the cable 56 begins to dispense. Preferably, the speed of the motor 52 is optimized to aid in the elimination of slack in the cable 56 and to improve the life of the motor 52. As the cable 56 is released from the reel 54, the material surface detector 30 begins to descend into the storage vessel 16 and the swing arm 58 is biased upwardly into their traveling positions 102, 104.

As the material surface detector 30 is being lowered, the hall effect sensors 74 monitor the position of the magnet 68, and thus the swing arm 58, and the same is reported to and monitored by the electronic control circuit 32. In addition, as the material surface detector 30 is being lowered the measuring wheel 78 is rotated by the cable 56. The rotating measuring wheel 78 causes the code wheel 80 to turn. The photo detector 86 in the optical encoder circuit 82 generates a pulse each time light passes through the code wheel 80. These pulses are transmitted to the electronic control circuit 32 where they are counted or otherwise analyzed. By counting the pulses, the dispensed length of the cable 56 can be calculated.

When the material surface detector 30 reaches the level 12 of the material 14, the downward force of gravity on the material surface detector is increasingly counteracted by the material 14. Therefore, the cable 56 begins to slacken. The slack in the cable 56 is generally absorbed by the swing arm 58 as the swing arm is biased upwardly by the biasing member. The hall effect sensors 74 can anticipate, based on the upward movement of the swing arm 58, when the swing arm will reach the material contact position 100. As such, the electronic control circuit 32, using the information relayed from the hall effect sensors 74, can deactivate the motor 52 at the most beneficial time. The undesirable bounce can therefore be mitigated and more accurate measurement results achieved.

The upward movement of the swing arm 58 and the lack of downward movement of the material surface detector 30 also causes the measuring wheel 78 to stop rotating. When the measuring wheel 78 stops, the code wheel 80 is correspondingly halted and the photo detectors 86 and/or the optical encoder circuit 82 report the discontinued rotation to the electronic control circuit 32. Once the swing arm 58 has ascended to the material contact position, the electronic control circuit 32 instructs the motor 52 to stop. Because the electronic control circuit 32 has been monitoring the input from the photo detectors 86, the electronic control circuit can adjust the pulse count for any bounce or other unexpected conditions that might have occurred during the descent.

After a predetermined amount of time, the electronic control circuit 32 instructs the motor 52 to begin operating in an opposite direction such that the cable 56 is now retracted. When the cable 56 is retracted, the photo detector 86 in the optical encoder circuit 82 once again begins generating and transmitting pulses. This time, the pulses represent the retracted length of the cable 56. As the material surface detector 30 is extracted or lifted from the level 12 of the material 14, the swing arm 58 and the material surface detector 30 each transition to their traveling positions 102, 104. Once again, the hall effect sensors 74 in the sensor circuit 60 monitor the position of the swing arm 58.

When the material surface detector 30 reaches and engages the socket 46, the material surface detector enters its socketed position 94. With the material surface detector 30 held firmly against the socket 46, the cable 56 can no longer be retracted and the tension on the cable 56 increases. This increased tension pulls the swing arm 58 downwardly towards its socketed position 96. The downward movement of the swing arm 58 also causes the measuring wheel 78 and code wheel 80 to stop turning. Therefore, the optical encoder circuit 82 discontinues sending pulses to the electronic control circuit 32. The socketed position 96 of the swing arm 58 is reported by the sensor circuit 60 to the electronic control circuit 32. In response, the electronic control circuit 32 halts the motor 52.

Similar to before, the hall effect sensors 74 can anticipate, based on the downward movement of the swing arm 58, when the swing arm will reach the socketed position 94. As such, the electronic control circuit 32, using the information relayed from the hall effect sensors 74, can once again deactivate the motor 52 at the most beneficial time. The undesirable bounce can therefore be mitigated and more accurate measurement results achieved.

In one embodiment, with the material surface detector 30 having been lowered and raised (i.e., undergone a measurement cycle), the electronic control circuit 32 compares the length of the cable 56 measured during the descent of the material surface detector 30 with the length of cable measured during the ascent of the material surface detector. If there is a substantial or excessive discrepancy between the two lengths, the electronic control circuit 32 reports an error. If no large difference is found, the electronic control circuit 32 employs an algorithm to determine the length of the cable 56, accounts for any bounce observed by the optical encoder circuit 82, and determines the level 12 of the material 14 in the storage vessel 16. Knowing the size and dimensions of the storage vessel 16, electronic control circuit 32 can determine the amount of material 14 as well.

The length of the cable 56, the level of the material 14, and/or the amount of material in the storage vessel 16 can be displayed, relayed, and/or utilized by using peripheral hardware components and/or software such as those described in Monitoring Bulletins 343A through 343D, which are available from Monitor Technologies, LLC, of Elbum, Ill.

From the foregoing, it can be seen that the above-noted monitor 10 provides substantial benefits. As those skilled in the art will recognize, knowing the position of the swing arm 58 at any given time is valuable information relating to the position or location of the material surface detector 30. This information can be combined with the information gathered by the optical encoder circuit 82 such that the electronic control circuit 32 is able to make better decisions and react more favorably in certain circumstances.

Also, due to the unique configuration of the monitor 10, the monitor is able to ascertain and alert a user of numerous conditions. For example, the user will be alerted to a broken cable 56 if the optical encoder circuit 82 is reporting no pulses or counts and the swing arm 58 is sensed in the material contact position. Also, the user will be notified when the material surface detector 30 has contacted the level 12 of the material 14 and is progressing toward an angle of repose if the optical encoder circuit 82 is reporting counts while the swing arm 58 is progressing toward the material contact position 100. As such, a mechanical brake commonly required by other known monitors is not needed. Also, the progression of the swing arm 58 in such a scenario might warrant the electronic control circuit 32 ignoring or discounting some of the pulses in arriving at a final pulse count. Further, the user will be advised when the material surface detector 30 is pulling out of the material 14 if the optical encoder circuit 82 is reporting counts and the swing arm 58 is rapidly moving toward the socketed position 96.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non- claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An apparatus for sensing a level of a material in a containment vessel, comprising:
a housing;
a surface detector carried by and movable relative to the housing, the surface detector adapted to engage the material;
a motor operatively connected to the surface detector;
a first sensor in sensory communication with the surface detector; and
a second sensor of a different type than the first sensor, the second sensor in sensory communication with the surface detector, the second sensor arranged to provide an indication as to the accuracy of the first sensor.

2. The apparatus of claim 1, wherein the first sensor is a hall effect sensor and the second sensor is an optical sensor.

3. The apparatus of claim 2, wherein the surface detector is a plumb bob secured to a cable, the cable wound about a reel, the reel coupled to the motor.

4. The apparatus of claim 1, wherein the apparatus further comprises an electronic control circuit, the electronic control circuit operatively coupled to the motor and the first and second sensors, the electronic control circuit receiving input from the first and second sensors and using the input to control operation of the motor.

5. The apparatus of claim 4, wherein the housing includes a bulkhead separating a mechanical compartment from an electrical compartment, the mechanical compartment housing the first sensor and the electrical compartment housing the electronic control circuit.

6. The apparatus of claim 5, wherein the housing further forms an optical compartment within the electrical compartment, the second sensor disposed in the optical compartment such that the first and second sensors are separated from each other by the housing and the second sensor is separated from the electrical compartment by the housing.

7. An apparatus for sensing a level of a material in a storage container, the apparatus comprising:
a housing;
means for extending and retracting a surface detector into and from the storage container, the means for extending and retracting disposed in the housing;
means for monitoring a surface detector position, the means for monitoring operably coupled to the means for dispensing and retracting, the means for monitoring disposed in the housing;
means for measuring a distance traveled by the surface detector within the storage container, the means for measuring operably coupled to the means for monitoring and disposed in the housing; and
an electronic control circuit disposed in the housing and operably coupled to the means for monitoring and the means for measuring, the electronic control circuit instructing the means for extending and retracting based upon input from the means for monitoring, the electronic control circuit receiving input from the means for measuring when the surface detector is dispensed and retracted such that the level of the material in the storage container is sensed.

8. The apparatus of claim 7, wherein the means for extending and retracting comprises a motor assembly, the motor assembly including a motor operably coupled to a storage reel holding cable.

9. The apparatus of claim 7, wherein the means for monitoring is a swing arm assembly having a swing arm and a sensor circuit, the swing arm pivotably secured to the housing and operably coupled to the surface detector, the swing arm having a magnet on a distal end, the sensor circuit capable of monitoring a magnetic flux generated by the magnet to determine a surface detector position.

10. The apparatus of claim 7, wherein the means for measuring is an optical assembly having a measuring wheel, a code wheel, and an optical encoder circuit, the measuring wheel operably coupled to the surface detector and the code wheel, the optical encoder circuit monitoring rotation of the code wheel.

11. The apparatus of claim 10, wherein the optical encoder circuit is configured to determine a direction of rotation of the code wheel.

12. The apparatus of claim 7, wherein the housing forms a bulkhead defining a mechanical compartment and an electrical compartment, the electronic control circuit disposed in the electrical compartment.

13. The apparatus of claim 12, wherein at least a portion of the means for extending and retracting, the means for monitoring, and the means for measuring is disposed in each of the mechanical compartment and the electrical compartment.

14. The apparatus of claim 7, wherein the distance traveled by the surface detector comprises an extended distance and a retracted distance, the extended distance and the retracted distance comparable by the electronic control circuit to determine if an error exists.

15. An apparatus for sensing a surface of material in a storage container, the apparatus comprising:
a housing;
a motor assembly disposed in the housing, the motor assembly having a motor and a reel carrying a cable;
a swing arm assembly disposed in the housing, the swing arm assembly having a swing arm and a sensor circuit, the swing arm pivotably secured to the housing and operably coupled to the cable, the swing arm having a magnet on a distal end, the sensor circuit capable of monitoring a magnetic field generated by the magnet to determine a surface detector position;
an optical assembly having a measuring wheel, a code wheel, and an optical encoder circuit, the measuring wheel operably coupled to the cable and the code wheel, the optical encoder circuit monitoring rotation of the code wheel;
a material surface detector operably coupled to the cable, the material surface detector moveable by the motor assembly between a first position where at least one of the housing and a top surface of the storage container are engaged and a second position where the surface of the material in the storage container is engaged; and
an electronic control circuit operably coupled to the motor, the sensor circuit, and the optical encoder circuit, the electronic control circuit instructing the motor to move the surface detector between the first and second positions based upon input from the sensor circuit, the electronic control circuit receiving input from the optical encoder circuit based on the rotation of the code wheel such that the surface of the material in the storage container is sensed.

16. The apparatus of claim 15, wherein the sensor circuit includes a hall effect sensor.

17. The apparatus of claim 15, wherein the optical encoder circuit is configured to determine a direction of rotation of the code wheel.

18. The apparatus of claim 15, wherein the housing includes a bulkhead, the bulkhead separating the swing arm from the sensor circuit.

19. The apparatus of claim 15, wherein the housing includes a bulkhead forming a mechanical compartment and an electrical compartment, the reel, the swing arm, the cable, and the measuring wheel disposed in the mechanical compartment and the motor, the sensor circuit disposed in the electrical compartment.

20. The apparatus of claim 19, wherein the housing forms an optical compartment within the electrical compartment, the optical encoder circuit disposed in the optical compartment.
